(19) United States
(12) Patent Application Publication
(10) Pub. No.: US 2023/0306721 A1
(43) Pub. Date: Sep. 28, 2023

(54) MACHINE LEARNING MODELS TRAINED FOR MULTIPLE VISUAL DOMAINS USING CONTRASTIVE SELF-SUPERVISED TRAINING AND BRIDGE DOMAIN

(71) Applicant: International Business Machines Corporation, Armonk, NY (US)

(72) Inventors: Leonid KARLINSKY, Mazkeret Batya (IL); Sivan HARARY, Haifa (IL); Eliyahu SCHWARTZ, Haifa (IL); Assaf ARBELLE, Lehvot Haviva (IL)

(21) Appl. No.: 17/705,597

(22) Filed: Mar. 28, 2022

(51) Int. Cl. G06V 10/774; G06N 3/04; G06V 10/82; G06V 10/74

(52) U.S. Cl. CPC G06V 10/774; G06N 3/0454; G06V 10/82; G06V 10/761

(57) ABSTRACT

An example a system includes a processor to receive a model that is a neural network and a number of training images. The processor can train the model using a bridge transform that converts the training images into a set of transformed images within a bridge domain. The model is trained using a contrastive loss to generate representations based on the transformed images.

### BACKGROUND

The present techniques relate to training machine learning models. More specifically, the techniques relate to training machine learning models for use with multiple visual domains.

### SUMMARY

According to an embodiment described herein, a system can include processor to receive a model including a neural network and a number of training images. The processor can also further train the model using a bridge transform that converts the training images into a set of transformed images within a bridge domain, where the model is trained using a contrastive loss to generate representations based on the transformed images. Thus, the system may enable training of a model that detects objects that are more similar in the bridge domain across different image domains. Preferably, the bridge transform includes a learned domain-specific model. In this embodiment, accuracy may be improved by training a domain-specific model for each image domain. Preferably, the bridge transform is applied to pairs of augmented images generated for each of the training images. In this embodiment, contrastive learning is enabled by generating augmented image pairs. Optionally, the bridge transform includes an edge map. In this embodiment, the edge map enables faster and simpler training using less memory. Preferably, the bridge transform includes a second neural network jointly trained with the model. In this embodiment, the use of a second neural network jointly trained may result in improved performance. Preferably, the training images include unlabeled images. In this embodiment, time and effort may be saved by not labeling images. Optionally, the bridge domain includes a shared auxiliary domain of edge-map-like images. In this embodiment, the use of edge-map like images may result in semantically grouped features across different image domains. Preferably, the system also includes a discriminator jointly trained with the model using an adversarial loss to detect a visual domain of the training images. In this embodiment, the discriminator may improve the domain invariance of projected representations used for training. Preferably, the system also includes a multi-domain queue to store positive keys from previous iterations of training to be used as negative keys for subsequent iterations of training. In this embodiment, use of a multi-domain queue with separate queues for each domain enables using per-domain queues to focus training on a separation inside the domains between the objects themselves, rather than between the different image domains. Optionally, the bridge transform is jointly trained using a bridge domain loss and an edge model. In this embodiment, the use of a bridge domain loss and an edge model may train the bridge transform to generate edge-like images that are more similar across different image domains.

According to another embodiment described herein, a method can include receiving, via a processor, a model including a neural network and a number of training images. The method can further include training, via the processor, the model using a bridge transform that converts the training images into a set of transformed images within a bridge domain, where the model is trained using a contrastive loss to generate representations based on the transformed images. Thus, the method may enable training of a model that detects objects that are more similar in the bridge domain across different image domains. Preferably, training the model includes augmenting each training image with different augmentations to generate an augmented pair of images, and generating the transformed images based on the augmented pair of training images via a bridge transform regularized across domains using a bridge domain model and a bridge domain loss. In this embodiment, the use of a regularized bridge transform across domains may enable the bridge transform to generate edge-like images that are more similar across different image domains. Preferably, training the model includes jointly training a domain discriminator to predict a domain of projected representations using an adversarial loss. In this embodiment, the discriminator may improve the domain invariance of projected representations used for training. Preferably, training the model includes training the model using the contrastive loss based on a projection of the augmented training images into a feature space aligned with the bridge domain. In this embodiment, using a contrastive loss along with projections of augmented images may enable improved performance of the trained model. Preferably, training the model includes generating positive keys at a momentum projection model and storing the positive keys to be used as negative keys in future iterations of training. In this embodiment, the use of positive keys as negative keys in future iterations of training may enable improved training of the model.

According to another embodiment described herein, a computer program product for training neural networks can include computer-readable storage medium having program code embodied therewith. The computer-readable storage medium is not a transitory signal per se. The program code executable by a processor to cause the processor to receive a model including a neural network and a number of training images. The program code can also cause the processor to train the model using a bridge transform that converts the training images into a set of transformed images within a bridge domain, where the model is trained using a contrastive loss to generate representations based on the transformed images. Thus, the computer program product may enable training of a model that detects objects that are more similar in the bridge domain across different image domains. Preferably, the computer-readable storage medium further includes program code executable by the processor to augment the training images with different augmentations to generate an augmented pair of images for each of the training images. In this embodiment, contrastive learning is enabled by generating augmented image pairs. Preferably, the computer-readable storage medium further includes program code executable by the processor to generate image transformed images based on the augmented pair of training images via a bridge transform regularized across domains using an edge model and a bridge domain loss. In this embodiment, the use of a bridge domain loss and an edge model may train the bridge transform to generate edge-like images that are more similar across different image domains. Preferably, the computer-readable storage medium further includes program code executable by the processor to jointly train a domain discriminator to predict a domain of projected representations using an adversarial loss. In this embodiment, the discriminator may improve the domain invariance of projected representations used for training. Preferably, the computer-readable storage medium further includes including program code executable by the processor to train the model using a contrastive loss based on representations of the transformed images in the bridge domain. In this embodiment, using a contrastive loss along with projections of augmented images may enable improved performance of the trained model.

According to an embodiment described herein, a system can include processor to receive a query including an image. The processor can also further input the query into a model iteratively trained using a bridge transform and contrastive learning to generate similar representations for images having similarity in a bridge domain. The processor can also receive, from the trained model, a number of images having similarity to the query in the bridge domain that is higher than similarity of other images in the dataset. Thus, the system may enable images with similar semantic meaning to be retrieved across different image domains. Optionally, the image of the query is from a first visual domain and the number of images retrieved from the trained model include an image from a second visual domain. In this embodiment, images of similar objects from the second visual domain may be retrieved using the first visual domain. Optionally, the image of the query and the number of images are from visual domains that are different than the visual domains of training images used to train the model. In this embodiment, images in visual domains not used during training may be retrieved without additional training.

According to another embodiment described herein, a method can include receiving, via a processor, a query including an image. The method can also further include inputting, via the processor, the query into a model iteratively trained using a bridge transform and contrastive learning to generate similar representations for images having similarity in a bridge domain. The method can also include receiving, at the processor from the trained model, a number of images having similarity to query in the bridge domain that is higher than similarity of other images in the dataset. Thus, the method may enable images with similar semantic meaning to be retrieved across different image domains. Preferably, the model is trained using domain-adaptive-adversarial contrastive learning with a domain discriminator. In this embodiment, the discriminator may improve the domain invariance of projected representations used for training.

### BRIEF DESCRIPTION OF THE SEVERAL VIEWS OF THE DRAWINGS

FIG. 1 is a block diagram of an example system for contrastive self-supervised training of a machine learning model using a bridge domain;

FIG. 2 is a block diagram of another example system for contrastive self-supervised training of a machine learning model using a bridge domain;

FIG. 3 is a block diagram of an example system for querying images from multiple visual domains using a model trained using a bridge domain;

FIG. 4 is a block diagram of an example bridge domain including three semantically aligned groups of projections from four different visual domains;

FIG. 5A is a process flow diagram of an example method that can train a machine learning model using a bridge domain and contrastive self-supervised learning loss;

FIG. 5B is a process flow diagram of another example method that can train a machine learning model using a bridge domain and contrastive self-supervised learning loss;

FIG. 6 is a process flow diagram of an example method that can query images using a machine learning model trained using a bridge domain and contrastive self-supervised learning loss;

FIG. 7 is a block diagram of an example computing device that can train machine learning models using contrastive self-supervised learning and a bridge domain;

FIG. 8 is a diagram of an example cloud computing environment according to embodiments described herein;

FIG. 9 is a diagram of an example abstraction model layers according to embodiments described herein; and

FIG. 10 is an example tangible, non-transitory computer-readable medium that can train machine learning models using contrastive self-supervised learning and a bridge domain.

### DETAILED DESCRIPTION

There are many applications for matching and retrieval of images across visual domains. One example, one application may be retrieving diagrams in a car or other equipment manuals using a photograph of a certain part or place in the car. Additional applications may include those of Augmented Reality (AR) where a technician interacts with information stored in a corpus of conventional technical literature automatically retrieved and placed in the “real world”. For example, the corpus may be a set of technical Portable Document Format (PDF) documents.

In all of these applications, matching across visual domains may pose various problems. For example, in technical manuals and other such documentation, often contain non-realistically looking schematic diagrams of the relevant equipment and its parts. This poses a challenge of how to match images across different imaging domains. For example, the visual domains may be a real photo and a schematic wireframe diagram, or sketch. Furthermore, some systems for such cross-domain retrieval may involve manual labeling to train. Thus, in real enterprise applications, there may be a significant cost factor involved in adapting such a system to new technical corpora and new clients. Such costs, if neglected, may make the application of such a system impractical. For example, the system may be either too costly or too slow to adapt.

According to embodiments of the present disclosure, a system includes a processor to receive a model including a neural network and a number of training images. The processor can train the model using a bridge transform that converts the training images into a set of transformed images within a bridge domain. The model is trained using a contrastive loss to generate representations based on the transformed images. Thus, embodiments of the present disclosure allow for an unsupervised domain generalization setup that does not have any training supervision in either source domain or any target domain. In particular, the embodiments described herein use auxiliary visual bridge domain to which all the domains of interest are relatively easily visually mapped in an image-to-image sense. Moreover, the bridge domain is only used during contrastive self-supervised training of the model for semantically aligning the feature representations of each of the training domains to the ones for the shared bridge domain. By transitivity of this semantic alignment in feature space, the learned model representations for all the domains are all bridge domain-aligned and hence implicitly aligned to each other. This alignment makes the learned mappings to the bridge domain unnecessary for inference, making the trained model generalizable even to new unseen domains at test time. Moreover, not depending on bridge domain-mapping at inference allows exploiting additional non-bridge domain-specific features, which may also be learned by a representation model encoder. For example, such non-bridge domain-specific features may include color or other visual characteristics. From experiments, it was shown that a simple heuristic implementation of the bridge domain, mapping images to their edge maps, resulted in improvement over strong self-supervised baselines not utilizing a bridge domain. Moreover, with a learnable bridge domain, the experiments demonstrated good gains across various datasets and tasks: including Unsupervised Domain Generalization (UDG), Few-Shot Unsupervised Domain Adaptation (FUDA), and a proposed task of generalization to different domains and classes. In particular, significant gains of up to 14% over UDG and up to 13:3% over FUDA respective state-of-the-art were demonstrated on several benchmarks, as well as showing significant advantages in transferring the learned representations without any additional fine-tuning to new unseen domains and object categories.

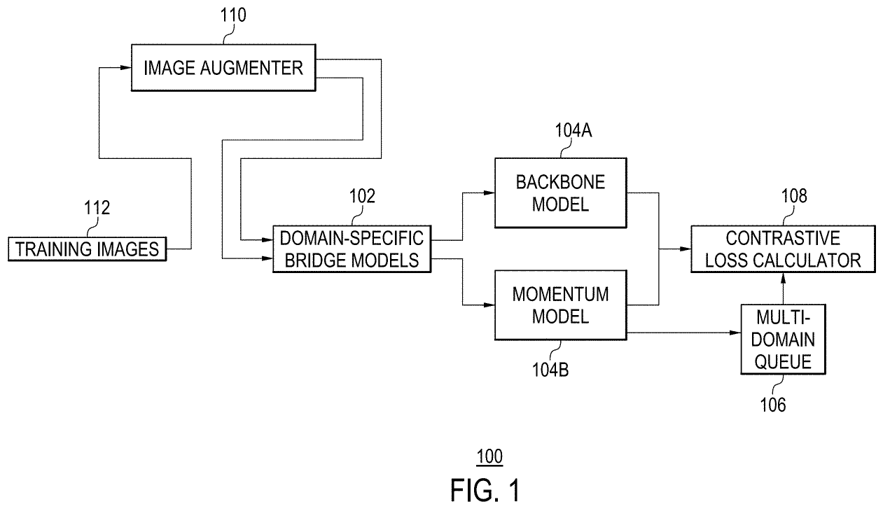

With reference now to FIG. 1, a block diagram shows an example system for contrastive self-supervised training of a machine learning model using a bridge domain. The example system is generally referred to by the reference number 100. The system 100 of FIG. 1 includes a domain-specific bridge mapper 102. The system 100 further includes an updated backbone model 104A and momentum model 104B communicatively coupled to the domain-specific bridge mapper. For example, the updated backbone model 104A and momentum model 104B may be convolutional neural networks. The system 100 also includes a multi-domain queue 106 communicatively coupled to the momentum model 104B. The system 100 also further includes a contrastive loss calculator 108 communicatively coupled to the updated backbone model 104A, the momentum model 104B, and the multi-domain queue 106. The system 100 also further includes image augmenter 110. The image augmenter 110 is shown receiving training images 112 outputting two augmented images as indicated by two arrows. For example, the training images 112 may be images from any number of visual domains. In various examples, the training images 112 are unlabeled. The augmented images may have any suitable random augmentations applied, such as random cropping, color jitter, flipping, random rotation, grayscale, or any other suitable augmentations.

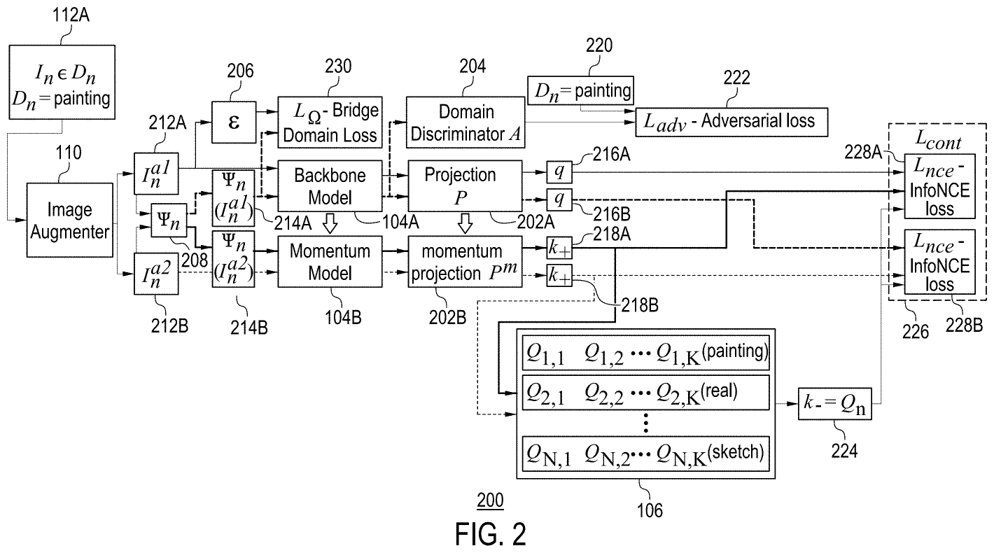

In the example of FIG. 1, the updated backbone model 104A may be trained to detect images with similar semantic meaning using a bridge domain and contrastive learning. For example, the domain-specific bridge models 102 can generate transformed images in a bridge domain. For example, the bridge domain may be a domain of edge-like images. In various examples, the domain-specific bridge models may be regularized using a bridge domain model, such as an edge model. In various examples, any other suitable bridge domain and bridge domain models may be used. In some examples, the training images 112 may first have random augmentations applied by the image augmenter 110, as described in greater detail in FIG. 2. For example, each training image 112 may be converted into two augmented images having different augmentations applied to the original training image 112. In various examples, the domain-specific bridge models 102 may then apply a bridge transform to the random augmentations.

The backbone model 104A and the momentum model 104B may receive representations in the bridge domain. In various examples, a pair of augmentations may be generated for each of the training images 112 and a first augmentation sent to the backbone model 104A and a second augmentation sent to the momentum model 104B. The backbone model 104A may then generate representations and the projection head may generate query representations 216A and 216B based on the representations. Similarly, the momentum model 104B can generate representations of received augmented image 212B and representation 214B and the momentum projection head may then generate positive keys 218A and 218B.

Still referring to FIG. 1, the positive keys may be stored in multi-domain queue 106 to be used in later iterations as negative keys. The multi-domain queue 106 may have previous positive keys stored in queues separated by image domain. The contrastive loss calculator 108 may thus use negative keys from a respective image domain in the multi-domain queue 106 and calculate the contrastive loss using the query from a projection head of the backbone model 104A and the positive keys from a projection head of the momentum model 104B. In various examples, additional losses may also be calculated during training. For example, an adversarial loss may be used to train a domain discriminator (not shown) as described in FIG. 2. In some examples, a bridge domain loss may also be calculated to regularize the domain-specific bridge models 102, as described in greater detail with respect to FIG. 2. In some examples, a full loss function with weights accorded to each of these loss functions may be used to train the system 100, as also described in greater detail with respect to FIG. 2.

It is to be understood that the block diagram of FIG. 1 is not intended to indicate that the system 100 is to include all of the components shown in FIG. 1. Rather, the system 100 can include fewer or additional components not illustrated in FIG. 1 (e.g., additional client devices, or additional resource servers, etc.).

FIG. 2 is a block diagram of another example system for contrastive self-supervised training of a machine learning model using a bridge domain. The example system 200 of FIG. 2 includes similarly numbered elements from FIG. 1. In particular, the system 200 includes the backbone model 104A and the momentum model 104B, which is a previous training iteration of the backbone model 104A. The backbone model 104A is shown generating momentum updates and sending the momentum updates to the momentum model 104B as indicated by an arrow. The system 200 also includes the multi-domain queue 106. The system includes an example training image 112A. For example, the training image 112A is an image of a painting.

The system 200 further includes a projection model 202A communicatively coupled to the backbone model 104A and a momentum projection model 202B communicatively coupled to the momentum model 104B. The system 200 includes a domain discriminator 204 communicatively coupled to the backbone model 104A. The system 200 also further includes an edge model 206 and a bridge transform 208 communicatively coupled to an image augmenter 110. The image augmenter 110 is shown generating two augmented images 212A and 212B. The bridge transform 208 is shown generating representations 214A and 214B. In various examples, the output representations 214A and 214B of bridge transform 208 are images with the same structure as the augmented images 212A and 212B. For example, the size, number of channels, and data type, of representations 214A and 214B may be the same as of the augmented images 212A and 212B. In particular, the structure of the representations 214A and 214B may match the structure of the augmented images 212A and 212B because the backbone model 104A is applied both on the augmented images 212A and 212B and the representations 214A and 214B. The combination of the projection model 202A and backbone model 104A is shown generating a pair of query representations 216A and 216B associated with augmented image 212A and transformed image 214A, respectively. In various examples, the query representations 216A and 216B are feature vectors in a feature space. The projection model 202A is also shown generating momentum updates and sending the momentum updates to the momentum projection model 202B as indicated by an arrow. The momentum projection model 202B is shown generating positive keys 218A and 218B, associated with transformed image 214B and augmented image 212B, respectively. In various examples, the positive keys 218A and 218B are also feature vectors in the feature space. The positive keys 218A and 218B are shown being stored in multi-domain queue 106. A ground truth label 220 indicating the domain of the training image 112A is shown being used to calculate an adversarial loss 222 for training the domain discriminator 204. The example ground truth label 220 of the training image 112A of FIG. 2 is a painting domain. In addition, the system 200 includes a negative key 224 shown being sampled from a domain corresponding to the image 112A the multi-domain queue 224. For example, the sampled negative key 224 may be a positive key stored in the corresponding domain queue from a previous iteration of training. The system 200 also is shown calculating a contrastive loss 226, which includes a first InfoNCE loss 228A and a second InfoNCE loss 228B. The system 200 includes a bridge domain loss 230 calculated using the edge model 206 and used to regularize the bridge transform 208. In addition, a solid lined arrow indicates the flow of augmented image 212A through the system 200, a bolded dashed lined arrow indicates the flow of transformed image 214A, a bolded solid arrow indicates the flow of transformed image 214B, and a dashed lined arrow indicates the flow of augmented image 212B.

In the example of FIG. 2, the image augmenter 110 can augment the training image 112A with two random augmentations to generate augmented images 212A and 212B. For example, the augmentations may include random cropping, color jitter, flipping, random rotation, grayscale, etc. A bridge transform 208 may be applied either on the augmented images 212A and 212B to generate transformed images in a bridge domain. This bridge transform 208 can be for example, an edge map or another neural network trained jointly with the backbone model 104A trained with a bridge model 206 using the bridge domain loss 230. In the example of FIG. 2, one augmented image 212B is used to generate positive keys 218A and 218B that are added to the queue 106 of previously seen images and the other augmented image 212A is used to generate query representations 216A and 216B that are compared to all the images in the queue 106. For example, the comparison may be performed in the feature space. The weights of the model 104A are updated iteratively using the contrastive loss 226 such that the query augmented image 212A corresponding to query representations 216A and 216B is closer to the positive keys 218A and 218B generated based on the other augmented image 212B than to the negative keys in the respective image domain of the queue 106.

As one specific example, a set of N domains may be used for training. For example, the N domains may be a pair of source and target domains in training for FUDA or a set of source domains in training for UDG. Each domain may be represented by a set of unlabeled images. In various examples, the system 200 may train the backbone model 104A to project any image from any of the domains into a d-dimensional feature representation such that the following equation will likely be satisfied:

C(Iₙ)=C(Iₘ)≠C(Iᵣ): ∥B(Iₙ)−B(Iₘ)∥<<∥B(Iₙ))−B(Iᵣ)∥ Eq. 1

where C is a class mapping that is unknown at training, Iₙ is an unlabeled image from a first domain, Iₘ and Iᵣ are unlabeled images from a second domain, and B is the trained backbone model 104A. In various examples, the representation space may be shared for all domains. An overall goal of the training may be that this semantic alignment property will also generalize to other domains, even if such other domains are not seen during training.

In various examples, the system 200 can train backbone model 104 using a contrastive self-supervised learning. As one example, this contrastive self-supervised learning may be performed by extending the MoCoV2 approach, first released March 2020, to incorporate bridge domain learning and other elements described herein. Specifically, the training architecture described in system 200 may include the following components. First, the backbone model 104A may be any suitable convolutional neural network. As one example, the backbone model 104A may use a ResNet50 network with d=2048. In various examples, the backbone model 104A may be the only component of system 200 kept after training. For example, the rest of the components of system 200 may be used for training only and later discarded. The projection head 202A may be a two-layer multilayer perceptron (MLP) with p=128 and with L2 normalization on top. In various examples, a pair of momentum models including the momentum model 104B and the momentum projection model 202B may be an exponential moving average (EMA)-only updated copies of backbone model 104A and projection model 202A respectively.

In various examples, the system 200 may include a separate negatives queue 224 for each of the domains. The separate negatives queue 224 may be used because separating between domains may be much easier than separating between classes. Moreover, using a separate negatives queue 224 for each of the domains may improve semantic accuracy.

In various examples, the system 200 includes the set of image-to-image models 208 for mapping each of the number of domains to the shared auxiliary bridge domain. For example, the auxiliary bridge domain may be shared across all seen and unseen domains. In some examples, the image-to-image models 208 are regularized via the edge model 206 and bridge domain loss 230 to produce edge-like images in the bridge domain. In some examples, the edge model 206 may be a Canny edge detector. In various examples, the edge model 206 may be a holistically-nested edge detection (HED) edge detector. For example, the edge model 206 may be a frozen holistically-nested edge detection (HED) edge detector pretrained on a dataset, such as the BSDS500 dataset. In some examples, the edge model 206 may be an HED model trained end-to-end with the other components of system 200. In particular, an end-to-end trained HED edge model 206 may learn to retain semantic details of shapes and textures. For example, such HED edge model 206 may learn to retain house windows, giraffe spots, or arms of people.

The domain discriminator 204 may be an adversarial domain classifier applied only to the transformed image 214A. The domain discriminator 204 may try to predict the original domain index n of the backbone model 104A when applied on the bridge transformed image 214A. In particular, training the backbone model 104A to produce representations that confuse the domain discriminator 204 better aligns the projections of all the different original domains inside the bridge domain.

In various example, in the training of system 200 may proceed in batches of images randomly sampled from all the training domains jointly. For clarity, FIG. 2 depicts the training flow with respect to a single input image 110 from an example painting image domain 220. In the example of FIG. 2, two augmentations 212A and 212B of image 110 may be generated using any suitable augmentation algorithm. A contrastive loss may be defined using the following equation:

[symbol]

_{cont}(Iₙ)= [symbol] _{nce}(P(B(Iₙ^{a1})),P^{m}(B^{m}(Ψₙ(Iₙ^{a2}))),Qₙ)+ [symbol] _{nce}(P(B(Ψₙ(Iₙ^{a1}))),P^{m}(B^{m}(Iₙ^{a2})),Qₙ) Eq. 2

where Iₙ^{a1} Iₙ^{a2} are the pair of augmentations 212A and 212B, Bis the backbone model 104A, B^{m} is the momentum model 104B, P is the projection 202A, P^{m} is the momentum projection 202B, Ψₙ is the image-to-image model 208 specific to domain n, and [symbol] _{nce}(q, k₊, k₋) is a standard InfoNCE loss with the query q, the positive key k+ that attracts q, and a set of negative keys k₋ that repulse q. In various examples, the InfoNCE losses 228A and 228B may use a cosine similarity to compare query representations 216A and 216B, and positive keys 218A, 218B, and 224. Since in both [symbol] _{nce} summands of Eq. 2, the positive keys k+ 218A and 218B are always encoded via the momentum models B^{m} 104B and P^{m} 202B not producing gradients, both of these [symbol] _{nce} may be used in order to train backbone model B 104A and projection model P 202A to represent both the original training domains images including image 110 and their bridge domain mappings 208. For example, the first [symbol] _{nce} of Eq. 2 teaches backbone model B 104A to extract relevant features directly from each image domain Dn. Thus, the bridge domain mapping models 208 may be discarded after training and the backbone model B 104A may be applied even to unseen domains for which a learned bridge domain mapping 208 may not exist.

In various examples, after each batch of training images is processed, a set of momentum representations, also referred to herein as positive keys 218A and 218B, of the batch of images may be circularly queued in the multi-domain queue 106 in accordance with their source domains. For example, the positive keys 218A and 218B may be queued in accordance with their source domains Dₙ according to the equation:

Qₙ←Qₙ∪{P^{m}(B^{m}(Ψₙ(Iₙ^{a2}))),P^{m}(B^{m}(Iₙ^{a2}))} Eq. 3

In various examples, maintaining a multi-domain queue 106 in this way enables domain Dₙ images from future training batches to contrast in feature space F not only against projections of other Dₙ images, but also against other images from domain Dₙ. For example, positive keys 218A and 218B stored in the multi-domain queue 106 may then be used as negative keys 224 in later iterations of training with training images from the same domain. Thus, the system 200 may enable representation backbone model B 104a to complement its set of-specific features with some Dₙ-specific ones. For example, such domain specific features may be color features, among other types of domain-specific features.

Additionally, in various examples, the system 200 may use an adversarial loss for jointly training the domain discriminator 204. For example, the following adversarial loss may be used to train domain discriminator 204:

[symbol]

_{adv}(Iₙ)=CE(A(B(Ψₙ(Iₙ^{a2}))),n) Eq. 4

where CE is a standard cross-entropy loss and n∈{1, . . . , N} is the correct domain index for the image Iₙ. In various examples, the system 200 may use any suitable adversarial training scheme for calculating adversarial loss [symbol] _{adv}. For example, the system 200 may use the two-optimizer scheme in PyTorch. In each training batch, the domain discriminator A 204 may minimize adversarial loss [symbol] _{adv}, while blocking the gradients of backbone model B 104A and bridge transform model Ψₙ 208, whereas backbone model B 104A and image-to-image model 208 may minimize the negative loss − [symbol] _{adv}, while blocking the gradients of discriminator A 204. In various examples, the system 200 may employ [symbol] _{adv} only for the projections of the original domains, thus not involving any direct alignment between the different image domains of D. In some examples, to reduce competition between adversarial loss [symbol] _{adv} and contrastive loss [symbol] _{cont}, the system 200 may use the domain discriminator A 204 directly on backbone model B 104A generated representations and not on the projection head P-generated representations. For example, the projection head P-generated representations may be temporary features used for efficiency in calculating [symbol] _{cont}. The use of domain discriminator A 204 and an adversarial loss [symbol] _{adv} may improve the domain invariance of the projected representations including query representations 216A and 216B, and positive keys 218A and 218B.

In various examples, the system 200 also includes a bridge domain loss 230 that regularizes the bridge transform models Ψₙ to produce edge-like images in a shared auxiliary bridge domain Ω. For example, the bridge domain loss 230 may be calculated using the equation:

[symbol]

_{Ω}(Iₙ)=∥Ψₙ(Iₙ^{a1})−Ψₙ(Iₙ^{a1})∥ Eq. 5

where E is some edge model, which could be heuristic, such as Canny edge detector, or pre-trained, such as an HED. The system 200 may thus apply the [symbol] ₙ regularization, distilling from an edge-mapping c 206, and thus forcing the bridge domain images 214A and 214B to be similar to edge maps 206, which may be less sensitive to domain shift.

In various examples, a full loss function for training system 200 using image Iₙ 112A may be therefore calculated using the equation:

[symbol]

_{f}(Iₙ)=α₁· [symbol] _{cont}(Iₙ)+α₂· [symbol] ₙ(Iₙ)+a₃· [symbol] _{adv}(Iₙ) Eq. 6

where α₁, α₂, and α₃, are weights applied to the contrastive loss 226, the bridge domain loss 202, and the adversarial loss 222, respectively, and the sign in front of [symbol] _{adv} becomes positive when computing gradients for training the adversarial domain discriminator A 204.

It is to be understood that the block diagram of FIG. 2 is not intended to indicate that the system 200 is to include all of the components shown in FIG. 2. Rather, the system 200 can include fewer or additional components not illustrated in FIG. 2 (e.g., additional client devices, or additional resource servers, etc.). For example, in some embodiments, training may start from an ImageNet pretrained model and a transductive paradigm may be used for the unlabeled domains data 112A. For example, a transductive paradigm may utilize an entire domain's data including unlabeled test data in training.

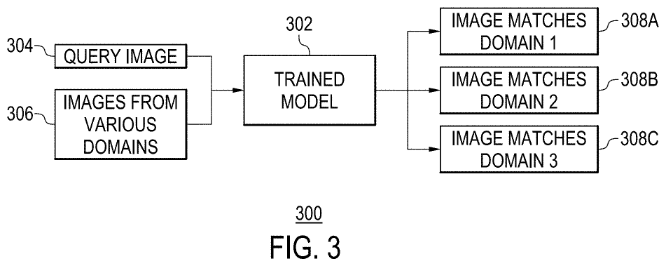

FIG. 3 is a block diagram of an example system for querying images from multiple visual domains using a model trained using a bridge domain. The example system 300 of FIG. 3 includes a trained model 302. For example, the trained model 302 may be the backbone model 104A of FIGS. 1 and 2. The system 300 further includes a query image 304 shown being received at the trained model 302. For example, the query image 304 may be an image from a particular visual domain including some object. The system 300 also include images from various domains 306. For example, the images from various domains 306 may be a repository of various images from any number of domains, such as images of sketches, photos, clipart, etc. The system 300 also further includes image matches from a first domain 308A, images matches from a second domain 308B, and images matches from a third domain 308C.

In the example of FIG. 3, at query time, also referred to herein as inference time, the trained model 302 is applied on the query image 304 and each image in the images from various domains 306. A matching between the images may then be performed in the feature space of the bridge domain. For example, the trained model 302 may generate a representation for each of the images 304 and 306 and match images 306 with the query image 304 based on the generated representations. For example, the representations may be feature vectors.

Still referring to FIG. 3, the result of the matching may be sets of image matches from various domains. For example, FIG. 3 shows three sets of image matches from a first domain 308A, a second domain 308B, and a third domain 308C. In some examples, each of the sets of image matches 308A, 308B, and 308C may include a predetermined number of closest matches to the query image 304 from each of the different visual domains. For example, given a query image 304 of a dog from a domain such as a clipart, the system 300 may generate a first set of image matches 308A containing images of dogs in a domain such as real photos, a second set of image matches 308B containing images of dogs in a domain such as clipart, and a third set of image matches 308C containing images of dogs in a domain such as sketches.

It is to be understood that the block diagram of FIG. 3 is not intended to indicate that the system 300 is to include all of the components shown in FIG. 3. Rather, the system 300 can include fewer or additional components not illustrated in FIG. 3 (e.g., additional client devices, or additional resource servers, etc.).

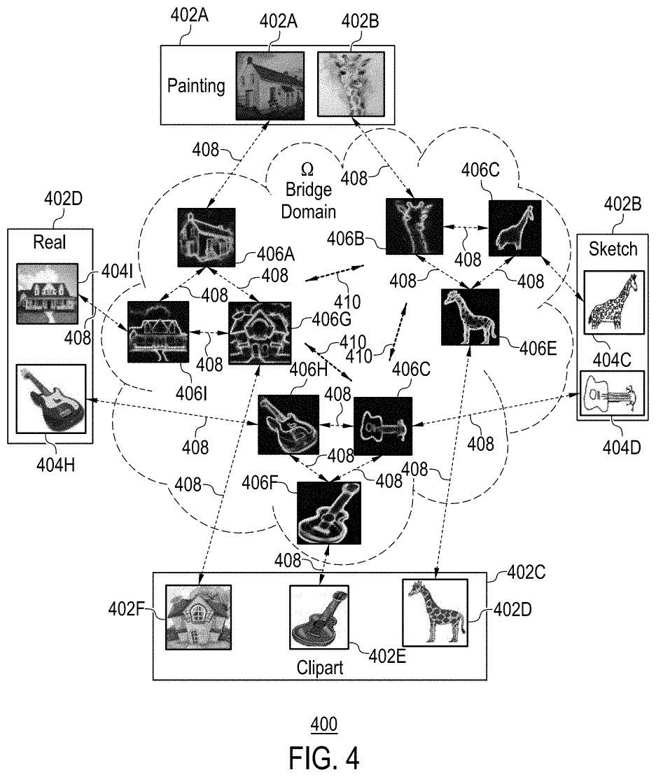

FIG. 4 is a diagram of an example bridge domain including projections from four different visual domains. The example bridge domain 400 of FIG. 4 includes a projections 402 of images from four different example visual domains. For example, the bridge domain 400 may be an auxiliary bridge domain of edge-like images. The example visual domains include a painting domain, a real image domain, a clipart domain, and a sketch domain.

In the example of FIG. 4, before training, same domain instances may be closer to each other than to instances of the same class in other domains. For example, a sketch of a giraffe may be closer to a sketch of a guitar rather than a painting of a giraffe or a clipart of a giraffe. In particular, naïve application of popular self-supervised learning techniques may tend to separate domains before classes. In the example of FIG. 4, the auxiliary bridge domain 400 helps in aligning instances of the same class across domains during training. A first set of dotted arrows indicate attractive forces in feature space applied by training losses. A second set of dashed arrows indicate repulsive forces applied by training losses. In particular, the training of FIG. 4 may have resulted in three semantically aligned groups of projections 402 corresponding to images of houses, images of giraffes, and images of guitars.

It is to be understood that the block diagram of FIG. 4 is not intended to indicate that the system 400 is to include all of the components shown in FIG. 4. Rather, the system 400 can include fewer or additional components not illustrated in FIG. 4 (e.g., additional client devices, or additional resource servers, etc.).

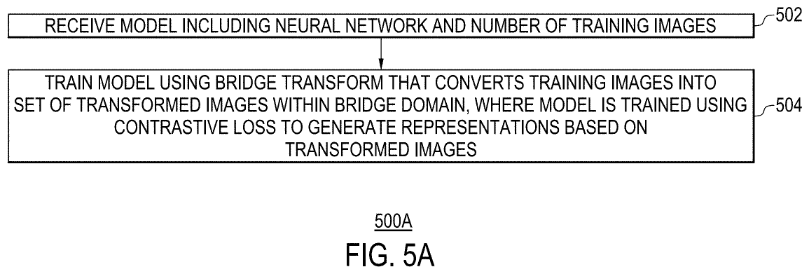

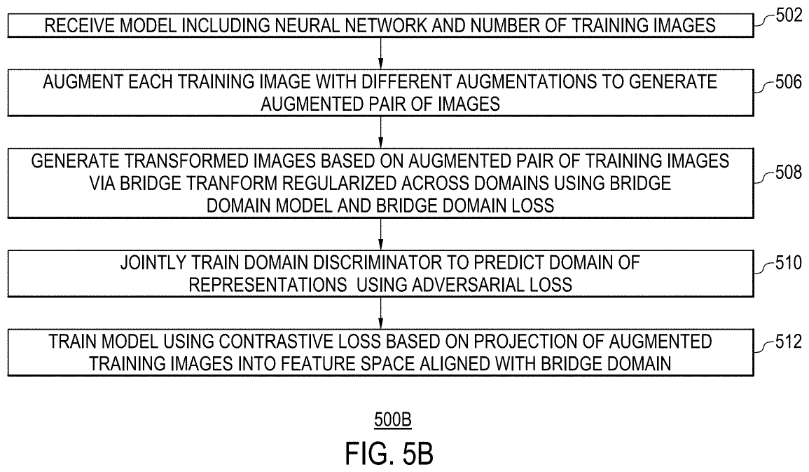

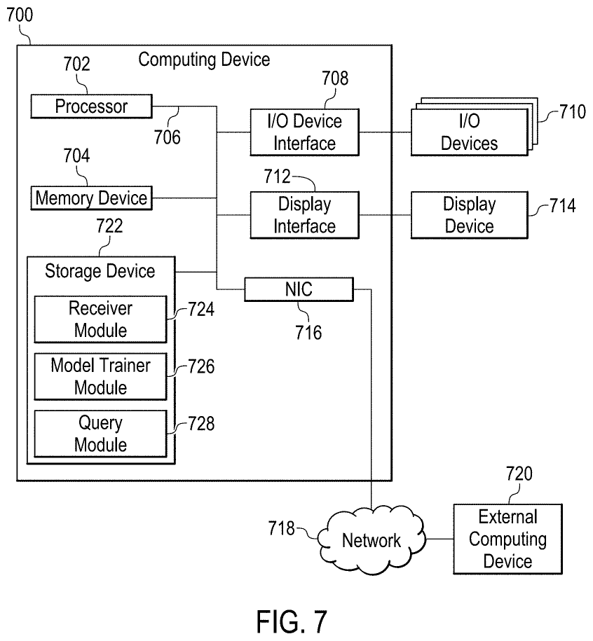

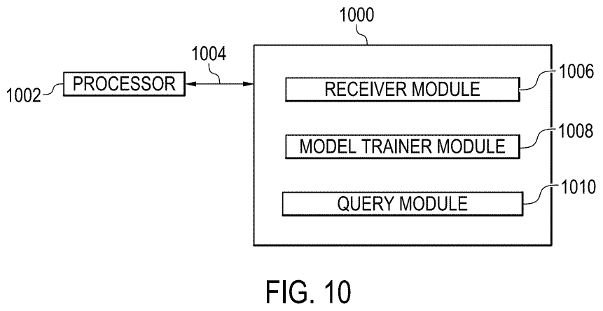

FIG. 5A is a process flow diagram of an example method that can train a machine learning model using a bridge domain and contrastive self-supervised learning loss. The method 500A can be implemented with any suitable computing device, such as the computing device 300 of FIG. 3 and with the systems 100 and 200 of FIGS. 1 and 2. For example, the methods described below can be implemented by the processor 702 or the processor 1002 of FIGS. 7 and 10.

At block 502, a processor receives a model including a neural network and a number of training images. For example, the model may be a convolutional neural network. In various examples, the training images may be from a number of different image domains.

At block 504, the processor trains the model using a bridge transform that converts the training images into a set of transformed images within a bridge domain, where the model is trained using a contrastive loss to generate representations based on the transformed images.

The process flow diagram of FIG. 5A is not intended to indicate that the operations of the method 500A are to be executed in any particular order, or that all of the operations of the method 500A are to be included in every case. Additionally, the method 500A can include any suitable number of additional operations.

FIG. 5B is a process flow diagram of another example method that can train a machine learning model using a bridge domain and contrastive self-supervised learning loss. The method 500B can be implemented with any suitable computing device, such as the computing device 300 of FIG. 3 and with the systems 100 and 200 of FIGS. 1 and 2. For example, the methods described below can be implemented by the processor 702 or the processor 1002 of FIGS. 7 and 10.

At block 502, a processor receives a model including a neural network and a number of training images. For example, the model may be a convolutional neural network. In various examples, the training images may be from a number of different image domains.

At block 506, the processor augments each training image with different augmentations to generate an augmented pair of images. For example, the augmentations may include cropping, color jitter, flipping of the image across horizontal or vertical axes, random rotation, and grayscale conversion, among other image augmentations.

At block 508, the processor generates transformed images based on the augmented pair of training images via a bridge transform regularized across domains using a bridge domain model and a bridge domain loss. For example, the bridge transform may be a neural network jointly trained with the model. In some examples, the bridge transform may be an edge map.

At block 510, the processor jointly trains a domain discriminator to predict a domain of the representations using an adversarial loss. For example, the domain discriminator may be trained using a representation of a transformed image as output by the model, and a ground truth label indicating the image domain of the training image used to generate the augmented image.

At block 512, the processor trains the model using the contrastive loss based on a projection of the augmented training images into a feature space aligned with the bridge domain. In some examples, the processor can generate positive keys at a momentum projection model and store the positive keys to be used as negative keys in future iterations of training. In various examples, the processor may calculate the contrastive loss using a summation of two InfoNCE losses. For example, the first InfoNCE loss may calculate a loss for a query, the positive key that attracts the query, and a set of negative keys that repulse the query. As one example, the queries may be generated by a projection head model and the positive keys may be generated using a momentum projection head model. In various examples, the negative keys may be retrieved from a multi-domain queue holding previous values of positive keys for each of a number of image domains.

The process flow diagram of FIG. 5B is not intended to indicate that the operations of the method 500B are to be executed in any particular order, or that all of the operations of the method 500B are to be included in every case. Additionally, the method 500B can include any suitable number of additional operations.

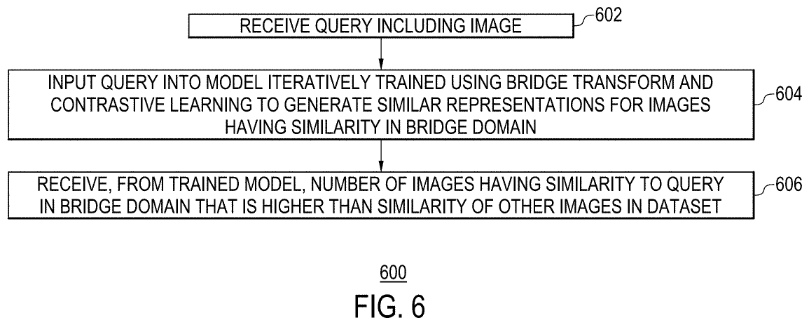

FIG. 6 is a process flow diagram of an example method that can query images using a machine learning model trained using a bridge domain and contrastive self-supervised learning loss. The method 600 can be implemented with any suitable computing device, such as the computing device 300 of FIG. 3 and with the systems 100 and 200 of FIGS. 1 and 2. For example, the methods described below can be implemented by the processor 702 or the processor 1002 of FIGS. 7 and 10.

At block 602, a processor receives a query including an image. For example, the image may be in any of a number of visual domains.

At block 604, the processor inputs the query into a model iteratively trained using a bridge transform and contrastive learning to generate similar representations for images having similarity in a bridge domain. For example, the model may have been trained using domain-adaptive-adversarial contrastive learning with a domain discriminator.

At block 606, the processor receives, from the trained model, a number of images having similarity to the query in the bridge domain that is higher than similarity of other images in the dataset. In some examples, the image of the query is from a first visual domain and the number of images retrieved from the trained model include an image from a second visual domain.

The process flow diagram of FIG. 6 is not intended to indicate that the operations of the method 600 are to be executed in any particular order, or that all of the operations of the method 600 are to be included in every case. Additionally, the method 600 can include any suitable number of additional operations.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

FIG. 7 is block diagram of an example computing device that can train machine learning models using contrastive self-supervised learning and a bridge domain. The computing device 700 may be for example, a server, desktop computer, laptop computer, tablet computer, or smartphone. In some examples, computing device 700 may be a cloud computing node. Computing device 700 may be described in the general context of computer system executable instructions, such as program modules, being executed by a computer system. Generally, program modules may include routines, programs, objects, components, logic, data structures, and so on that perform particular tasks or implement particular abstract data types. Computing device 700 may be practiced in distributed cloud computing environments where tasks are performed by remote processing devices that are linked through a communications network. In a distributed cloud computing environment, program modules may be located in both local and remote computer system storage media including memory storage devices.

The computing device 700 may include a processor 702 that is to execute stored instructions, a memory device 704 to provide temporary memory space for operations of said instructions during operation. The processor can be a single-core processor, multi-core processor, computing cluster, or any number of other configurations. The memory 704 can include random access memory (RAM), read only memory, flash memory, or any other suitable memory systems.

The processor 702 may be connected through a system interconnect 706 (e.g., PCI®, PCI-Express®, etc.) to an input/output (I/O) device interface 708 adapted to connect the computing device 700 to one or more I/O devices 710. The I/O devices 710 may include, for example, a keyboard and a pointing device, wherein the pointing device may include a touchpad or a touchscreen, among others. The I/O devices 710 may be built-in components of the computing device 700, or may be devices that are externally connected to the computing device 700.

The processor 702 may also be linked through the system interconnect 706 to a display interface 712 adapted to connect the computing device 700 to a display device 714. The display device 714 may include a display screen that is a built-in component of the computing device 700. The display device 714 may also include a computer monitor, television, or projector, among others, that is externally connected to the computing device 700. In addition, a network interface controller (NIC) 716 may be adapted to connect the computing device 700 through the system interconnect 706 to the network 718. In some embodiments, the NIC 716 can transmit data using any suitable interface or protocol, such as the internet small computer system interface, among others. The network 718 may be a cellular network, a radio network, a wide area network (WAN), a local area network (LAN), or the Internet, among others. An external computing device 720 may connect to the computing device 700 through the network 718. In some examples, external computing device 720 may be an external webserver 720. In some examples, external computing device 720 may be a cloud computing node.

The processor 702 may also be linked through the system interconnect 706 to a storage device 722 that can include a hard drive, an optical drive, a USB flash drive, an array of drives, or any combinations thereof. In some examples, the storage device may include a receiver module 724, a model trainer module 726, and a query module 728. The receiver module 724 can receive a model including a neural network and a number of training images. For example, the training images may include unlabeled images. The model trainer module 726 can train the model using a bridge transform that converts the training images into a set of transformed images within a bridge domain. For example, the model is trained using a contrastive loss to generate representations based on the transformed images. In some examples, the bridge transform includes a learned domain-specific model. In various examples, the bridge transform is applied to pairs of augmented images generated for each of the training images. In some examples, the bridge transform includes an edge map. In various examples, the bridge transform includes a second neural network jointly trained with the model. In various examples, the bridge domain includes a shared auxiliary domain of edge-map-like images. In some examples, the model trainer module 726 may include a discriminator jointly trained with the model using an adversarial loss to detect a visual domain of the training images. In various examples, the model trainer module 726 may include a multi-domain queue to store positive keys from previous iterations of training to be used as negative keys for subsequent iterations of training. The query module 728 can receive a query including an image and input the query into a model iteratively trained using a bridge transform and contrastive learning to generate similar representations for images having similarity in a bridge domain. The query module 728 can then receive, from the trained model, a number of images having similarity to the query in the bridge domain that is higher than similarity of other images in the dataset. In some examples, the image of the query is from a first visual domain and the number of images retrieved from the trained model include an image from a second visual domain. In various examples, the image of the query and the number of images are from visual domains that are different than the visual domains of training images used to train the model.

It is to be understood that the block diagram of FIG. 7 is not intended to indicate that the computing device 700 is to include all of the components shown in FIG. 7. Rather, the computing device 700 can include fewer or additional components not illustrated in FIG. 7 (e.g., additional memory components, embedded controllers, modules, additional network interfaces, etc.). Furthermore, any of the functionalities of the receiver module 724, the model trainer module 726, and the query module 728 may be partially, or entirely, implemented in hardware and/or in the processor 702. For example, the functionality may be implemented with an application specific integrated circuit, logic implemented in an embedded controller, or in logic implemented in the processor 702, among others. In some embodiments, the functionalities of the receiver module 724, model trainer module 726, and query module 728 can be implemented with logic, wherein the logic, as referred to herein, can include any suitable hardware (e.g., a processor, among others), software (e.g., an application, among others), firmware, or any suitable combination of hardware, software, and firmware.

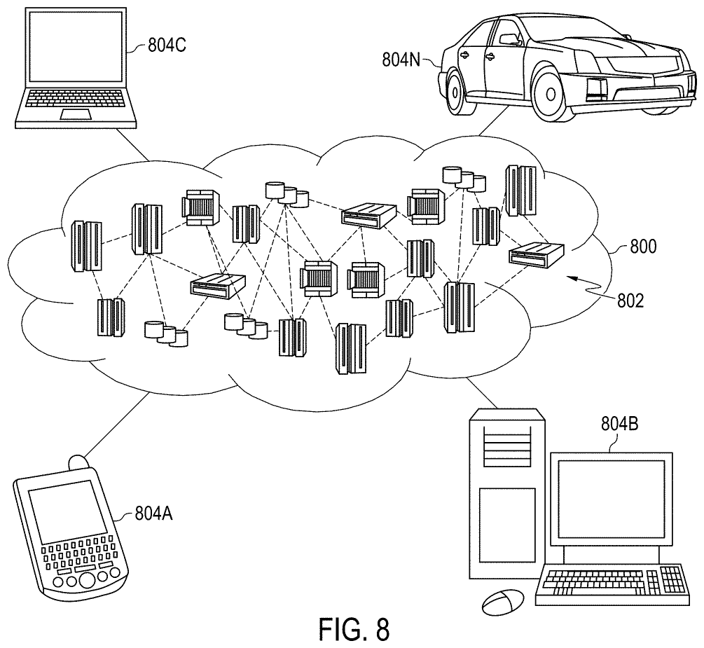

Referring now to FIG. 8, illustrative cloud computing environment 800 is depicted. As shown, cloud computing environment 800 includes one or more cloud computing nodes 802 with which local computing devices used by cloud consumers, such as, for example, personal digital assistant (PDA) or cellular telephone 804A, desktop computer 804B, laptop computer 804C, and/or automobile computer system 804N may communicate. Nodes 802 may communicate with one another. They may be grouped (not shown) physically or virtually, in one or more networks, such as Private, Community, Public, or Hybrid clouds as described hereinabove, or a combination thereof. This allows cloud computing environment 800 to offer infrastructure, platforms and/or software as services for which a cloud consumer does not need to maintain resources on a local computing device. It is understood that the types of computing devices 804A-N shown in FIG. 8 are intended to be illustrative only and that computing nodes 802 and cloud computing environment 800 can communicate with any type of computerized device over any type of network and/or network addressable connection (e.g., using a web browser).

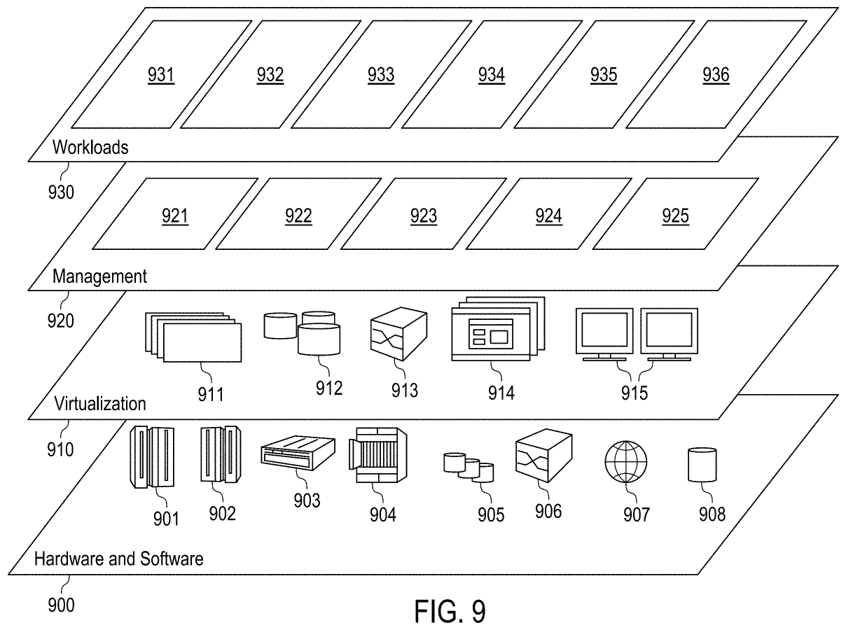

Referring now to FIG. 9, a set of functional abstraction layers provided by cloud computing environment 800 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 900 includes hardware and software components. Examples of hardware components include: mainframes 901; RISC (Reduced Instruction Set Computer) architecture based servers 902; servers 903; blade servers 904; storage devices 905; and networks and networking components 906. In some embodiments, software components include network application server software 907 and database software 908.

Virtualization layer 910 provides an abstraction layer from which the following examples of virtual entities may be provided: virtual servers 911; virtual storage 912; virtual networks 913, including virtual private networks; virtual applications and operating systems 914; and virtual clients 915.

In one example, management layer 920 may provide the functions described below. Resource provisioning 921 provides dynamic procurement of computing resources and other resources that are utilized to perform tasks within the cloud computing environment. Metering and Pricing 922 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 923 provides access to the cloud computing environment for consumers and system administrators. Service level management 924 provides cloud computing resource allocation and management such that required service levels are met. Service Level Agreement (SLA) planning and fulfillment 925 provide pre-arrangement for, and procurement of, cloud computing resources for which a future requirement is anticipated in accordance with an SLA.

Workloads layer 930 provides examples of functionality for which the cloud computing environment may be utilized. Examples of workloads and functions which may be provided from this layer include: mapping and navigation 931; software development and lifecycle management 932; virtual classroom education delivery 933; data analytics processing 934; transaction processing 935; and multi-domain visual machine learning model training 936.

The present invention may be a system, a method and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, or either code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the techniques. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Referring now to FIG. 10, a block diagram is depicted of an example tangible, non-transitory computer-readable medium 1000 that can train machine learning models using contrastive self-supervised learning and a bridge domain. The tangible, non-transitory, computer-readable medium 1000 may be accessed by a processor 1002 over a computer interconnect 1004. Furthermore, the tangible, non-transitory, computer-readable medium 1000 may include code to direct the processor 1002 to perform the operations of the methods 500A, 500B, and 600 of FIGS. 5A, 5B, and 6.

The various software components discussed herein may be stored on the tangible, non-transitory, computer-readable medium 1000, as indicated in FIG. 10. For example, a receiver module 1006 includes code to receive a model including a neural network and a number of training images. A model trainer module 1008 includes code to train the model using a bridge transform that converts the training images into a set of transformed images within a bridge domain. For example, the model is trained using a contrastive loss to generate representations based on the transformed images. The model trainer module 1008 further includes code to augment the training images with different augmentations to generate an augmented pair of images for each of the training images. The model trainer module 1008 also includes code to generate the transformed images based on the augmented pair of training images via a bridge transform regularized across domains using an edge model and a bridge domain loss. In some examples, the model trainer module 1008 also includes code to jointly train a domain discriminator to predict a domain of projected representations using an adversarial loss. In some examples, the model trainer module 1008 also includes code to train the model using a contrastive loss based on representations of the transformed images in the bridge domain. A query module 1010 includes code to receive a query including an image. The query module 1010 also includes code to input the query into a model iteratively trained using a bridge transform and contrastive learning to generate similar representations for images having similarity in a bridge domain. The query module 1010 also includes code to receive, from the trained model, a number of images having similarity to the query in the bridge domain that is higher than similarity of other images in the dataset. In some examples, the image of the query is from a first visual domain and the number of images retrieved from the trained model include an image from a second visual domain. In various examples, the image of the query and the number of images are from visual domains that are different than the visual domains of training images used to train the model.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. It is to be understood that any number of additional software components not shown in FIG. 10 may be included within the tangible, non-transitory, computer-readable medium 1000, depending on the specific application.

The descriptions of the various embodiments of the present techniques have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising a processor to:
receive a model comprising a neural network and a plurality of training images; and
train the model using a bridge transform that converts the training images into a set of transformed images within a bridge domain, wherein the model is trained using a contrastive loss to generate representations based on the transformed images.

2. The system of claim 1, wherein the bridge transform comprises a learned domain-specific model.

3. The system of claim 1, wherein the bridge transform is applied to pairs of augmented images generated for each of the training images.

4. The system of claim 1, wherein the bridge transform comprises an edge map.

5. The system of claim 1, wherein the bridge transform comprises a second neural network jointly trained with the model.

6. The system of claim 1, wherein the training images comprise unlabeled images.

7. The system of claim 1, wherein the bridge domain comprises a shared auxiliary domain of edge-map-like images.

8. The system of claim 1, comprising a discriminator jointly trained with the model using an adversarial loss to detect a visual domain of the training images.

9. The system of claim 1, comprising a multi-domain queue to store positive keys from previous iterations of training to be used as negative keys for subsequent iterations of training.

10. The system of claim 1, wherein the bridge transform is jointly trained using a bridge domain loss and an edge model.

11. A computer-implemented method, comprising:
receiving, via a processor, a model comprising a neural network and a plurality of training images; and
training, via the processor, the model using a bridge transform that converts the training images into a set of transformed images within a bridge domain, wherein the model is trained using a contrastive loss to generate representations based on the transformed images.

12. The computer-implemented method of claim 11, wherein training the model comprises augmenting each training image with different augmentations to generate an augmented pair of images, and generating the transformed images based on the augmented pair of training images via a bridge transform regularized across domains using a bridge domain model and a bridge domain loss.

13. The computer-implemented method of claim 11, wherein training the model comprises jointly training a domain discriminator to predict a domain of projected representations using an adversarial loss.

14. The computer-implemented method of claim 11, wherein training the model comprises training the model using the contrastive loss based on a projection of the augmented training images into a feature space aligned with the bridge domain.

15. The computer-implemented method of claim 11, wherein training the model comprises generating positive keys at a momentum projection model and storing the positive keys to be used as negative keys in future iterations of training.

16. A computer program product for training neural networks, the computer program product comprising a computer-readable storage medium having program code embodied therewith, wherein the computer-readable storage medium is not a transitory signal per se, the program code executable by a processor to cause the processor to:
receive a model comprising a neural network and a plurality of training images; and
train the model using a bridge transform that converts the training images into a set of transformed images within a bridge domain, wherein the model is trained using a contrastive loss to generate representations based on the transformed images.

17. The computer program product of claim 16, further comprising program code executable by the processor to augment the training images with different augmentations to generate an augmented pair of images for each of the training images.

18. The computer program product of claim 16, further comprising program code executable by the processor to generate transformed images based on the augmented pair of training images via a bridge transform regularized across domains using an edge model and a bridge domain loss.

19. The computer program product of claim 16, further comprising program code executable by the processor to jointly train a domain discriminator to predict a domain of projected representations using an adversarial loss.

20. The computer program product of claim 16, further comprising program code executable by the processor to train the model using a contrastive loss based on representations of the transformed images in the bridge domain.

21. A system, comprising a processor to:
receive a query comprising an image;
input the query into a model iteratively trained using a bridge transform and contrastive learning to generate similar representations for images having similarity in a bridge domain; and
receive, from the trained model, a plurality of images having similarity to the query in the bridge domain that is higher than similarity of other images in the dataset.

22. The system of claim 21, wherein the image of the query is from a first visual domain and the plurality of images retrieved from the trained model comprise an image from a second visual domain.

23. The system of claim 21, wherein the image of the query and the plurality of images are from visual domains that are different than the visual domains of training images used to train the model.

24. A computer-implemented method, comprising:
receiving, via a processor, a query comprising an image;
inputting, via the processor, the query into a model iteratively trained using a bridge transform and contrastive learning to generate similar representations for images having similarity in a bridge domain; and
receiving, at the processor from the trained model, a plurality of images having similarity to query in the bridge domain that is higher than similarity of other images in the dataset.

25. The computer-implemented method of claim 24, wherein the model is trained using domain-adaptive-adversarial contrastive learning with a domain discriminator.
